(19) United States
(12) Patent Application Publication
(10) Pub. No.: US 2001/0018296 A1
(43) Pub. Date: Aug. 30, 2001

(54) Connector modules

(75) Inventor: Jacky Philippe, Houtaud (FR)

Correspondence Address: PERMAN & GREEN, 425 POST ROAD, FAIRFIELD, CT, 06430, US

(73) Assignee: Framatome Connectors International

(21) Appl. No.: 09/735,180

(22) Filed: Dec. 12, 2000

(30) Foreign Application Priority Data
Dec. 13, 1999 (FR) FR 99/15697

(51) Int. Cl. H01R 13/64

(52) U.S. Cl. 439/680

(57) ABSTRACT

The invention relates to a connector module set (12) consisting of at least one male module and at least one female module, which are designed to be coupled to establish an electric connection.

The module (2) not associated with the receptacle (18) includes an antirotation member (10) which is designed to be inserted in a housing (14) formed in said receptacle (18), said antirotation member (10) being adapted to ensure both keying and guiding functions when said two modules are coupled.

The present invention relates to connector module sets being designed to establish a mechanical and electric connection between electric connectors. This connection is ensured by coupling at least one male module with one female module and generally by coupling several male modules with as many female modules.

In the art of electronics, the present trend is to design connectors having a high density of electric contacts (high density connectors) while minimizing their overall size.

In order to optimize the number of electric contacts, a higher number of contact elements must be provided, the latter having an increasingly reduced size.

Due to this constraint a highly accurate coupling is required between these contact elements, to prevent the latter from being deteriorated as a result of improper handling during coupling.

Attention further has to be paid that, during coupling operations, the male element is well connected with the female element specifically assigned thereto.

European Patent 0 443 492 describes a connector device having power contacts protected by the provision of an aligning member and a keying member. These two members have appropriate lengths to ensure contact elements are aligned and keyed before being coupled.

Nevertheless, these two elements, which are disposed inside the network of contact elements, occupy a space which might advantageously be used to increase the number of electric contacts on the connector device. Further, they hinder the desired purpose to miniaturize connector modules.

Moreover, the provision of these guiding and keying members involves a certain number of constraints for connector manufacturers, as regards the fabrication of these connector devices.

Other structures exist and provide a guiding and possibly a keying function, when a male connector module is to be fitted in a female module, thanks to a clip system situated on the side faces of the modules. While these structures improve connection density per module surface unit, electric contact elements are found to be exposed to degradation due to rotation mainly occurring while coupling and uncoupling the male module and the female module.

Particularly, in the so-called “backplane” connectors, whose outputs are connected to power cords, this rotation occurs very frequently, and in time this results in ruptures of the electric contact.

The present invention proposes a solution to the above drawbacks, by providing a connector set which reduces the risk of electric contact deterioration, caused by rotation, while allowing connection between contacts.

In accordance with the invention, the connector module set, consisting of at least one male module and at least one female module which are designed to be coupled together to establish an electric connection, one of said modules being associated with a receptacle, is so arranged that the module not associated with the receptacle has at least one antirotation member, which is designed to be inserted in a housing formed in said receptacle and provides both guiding and keying functions when said two modules are coupled.

Thanks to its guiding, keying and rotation-preventing features, this member ensures the male module can be coupled to the female module with no risk to deteriorate electric contacts.

Preferably, the housing and the antirotation member are complementary in shape and have respective parallel side walls acting as abutment surfaces which extend in the direction of insertion of the male module in the female module.

When the modules are coupled the side walls of the antirotation member abut against the side walls of the housing wherein the antirotation member fits.

The faces shared by the housing and this antirotation member being at least three in number (the side faces and the face of the receptacle between these two side faces), electric contact coupling is assured with no contact deterioration.

Advantageously, the antirotation member projects out of the module not associated with the receptacle, in a plane parallel to the side faces of the receptacle, in such a manner that, when the male and female modules are driven closer for coupling, the respective side walls of the antirotation member and of the housing abut against each other to tightly guide said member in said housing.

Therefore, when the antirotation member fits in the housing, it provides both guiding and keying functions for electric connection of contacts. Its presence allows to ensure that the modules are coupled with no risk of being deteriorated.

Also, contact density may be increased.

Additional features of the invention will be apparent from the following description, which is provided in the form of non-limiting embodiments with reference to the accompanying figures in which:

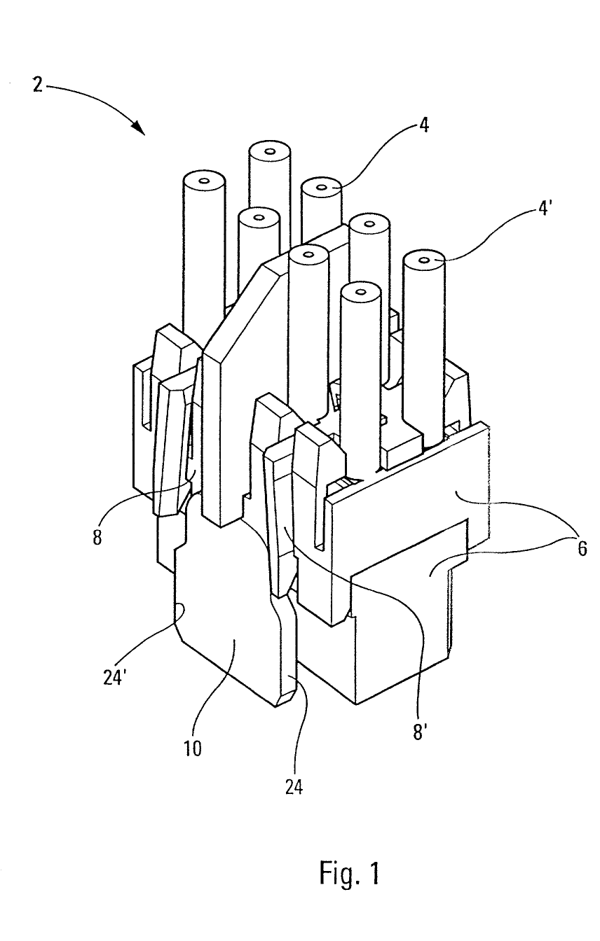

FIG. 1 is a general view of a connector module having an antirotation member according to the invention;

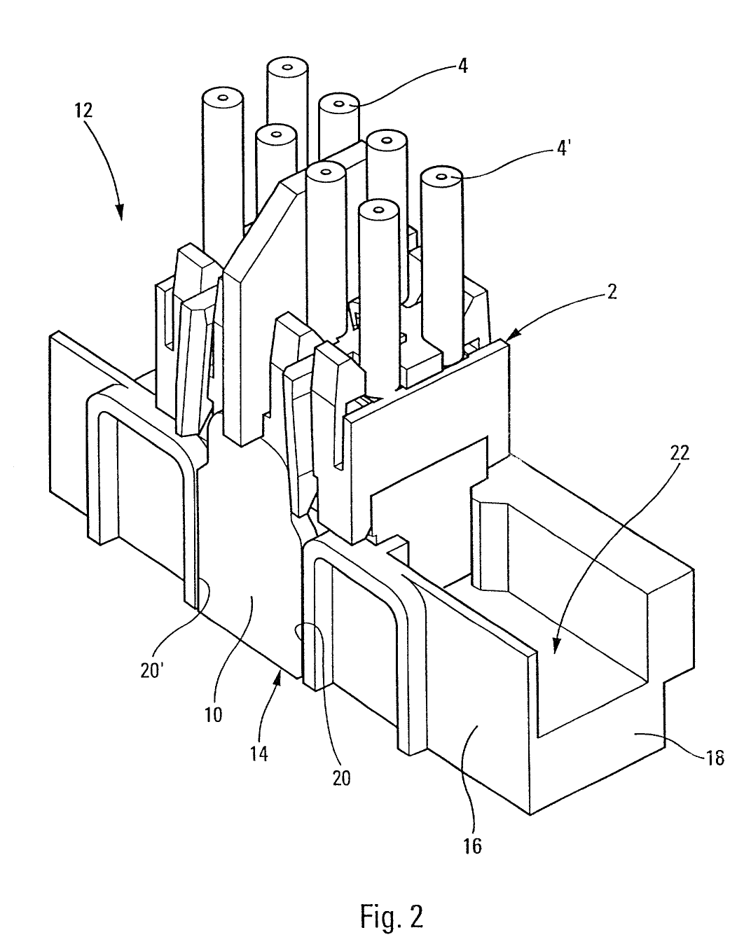

FIG. 2 is a general view of two coupled connector modules;

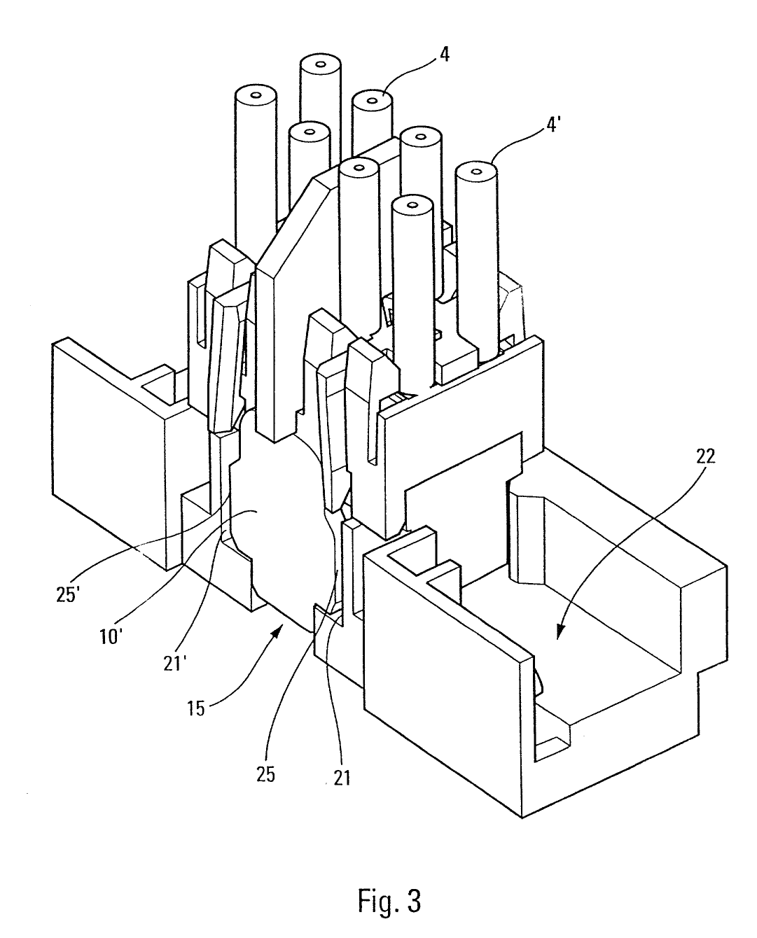

FIG. 3 is a general view of two coupled connector modules according to a variant embodiment.

In FIG. 1, the connector module 2 not associated with a receptacle, has electric contacts (not shown) connected to wires 4, 4′. The whole structure rests on a socket 6, particularly comprising branches 8, 8′, which allow to keep the cables and the associated contacts in position, when the latter have been fitted in their respective cavities.

The antirotation member 10 may be molded from the same material as the module 2 not associated with the receptacle.

This antirotation member 10 may as well be positioned after the fabrication of the connector module 2 by any means, such as by clip-fastening or gluing.

In one embodiment, this antirotation member 10 is a solid member, having a rectangular cross section and being possibly made of plastic.

FIG. 2 shows a connector module set 12 formed by coupling the connector module 2 of FIG. 1 to a mating module associated with a receptacle 18.

The antirotation member 10 is fitted in the housing 14 provided on one of the side faces 16 of the receptacle 18. It occupies all the volume extending between the side walls 20, 20′ of the housing 14 after each male module has been coupled to the female module.

This receptacle 18 has a U-shaped cross section 22, which is designed to accommodate the connector module 2 and includes a mating connector module which is arranged to be coupled to the module 2 to establish an electric connection.

In accordance with a particular embodiment (not shown) the module not associated with the receptacle may have two antirotation members inserted on both sides of the opposite faces 16 of the receptacle.

According to a variant embodiment of the invention, as shown in FIG. 3, the antirotation member 10′ is designed to be fitted both in the housing 14 as shown in FIG. 2, and in a housing 15 as shown in FIG. 3, in which the two side walls 21, 21′ of the housing have each one undercut projecting inside said housing 15.

In such a configuration, the side walls 25, 25′ of the antirotation member 10′ come to contact with the side walls 21, 21′ of the housing 15.

Hence, this embodiment of the antirotation member 10′ allows to connect the same module 2 to mating modules associated with receptacles having housings 14, 15 of different shapes.

In this configuration, the antirotation member 10′ has such a size as to provide the set with a maximized abutment surface, allowing to effectively prevent rotation of a module with respect to the other.

Each module not associated with the receptacle may be inserted in a block, regardless of the shape of the housings 14, 15.

Also, the receptacle may be a part of a connector block.

In this configuration, two connector blocks may be arranged to be connected, the one having modules provided with antirotation members, the other having housings designed to receive antirotation members when the male modules are coupled with the mating female modules.

1. A connector module set, consisting of at least one male module and at least one female module which are designed to be coupled together to establish an electric connection, one of said modules being associated with a receptacle (18), characterized in that the module (2) not associated with the receptacle (18) has at least one antirotation member (10, 10′), which is designed to be inserted in a housing (14, 15) formed in said receptacle (18) and provides both guiding and keying functions when said two modules are coupled.

2. A set as claimed in claim 1, characterized in that the housing (14, 15) and the antirotation member (10, 10′) are complementary in shape and have respective parallel side walls (20, 20′, 21, 21′, 24, 24′, 25, 25′) acting as abutment surfaces which extend in the direction of insertion of the male module in the female module.

3. A set as claimed in claim 1 or 2, characterized in that the antirotation member (10, 10′) projects out of the module (2) not associated with the receptacle, in a plane parallel to the side faces (16) of the receptacle (18), in such a manner that, when the male and female modules are driven closer for coupling, the respective side walls (24, 24′, 25, 25′, 20, 20′, 21, 21′) of the antirotation member (10, 10′) and of the housing (14, 15) abut against each other to tightly guide said member (10, 10′) in said housing (14, 15).

4. A set as claimed in any claims 1 to 3, characterized in that the antirotation member (10, 10′) is a solid member, having a rectangular cross section.

5. A set as claimed in claim 4, characterized in that the antirotation member (10, 10′) may be molded from the same material as the module (2) not associated with the receptacle.

6. A set as claimed in claim 4, characterized in that the antirotation member (10, 10′) is glued on the module (2) not associated with the receptacle (18).

7. A set as claimed in any claims 1 to 6, characterized in that the antirotation member (10, 10′) is made of plastic.

8. A set as claimed in any claims 1 to 7, characterized in that, after coupling each male module to the female module, the antirotation member (10, 10′) occupies fully or partly the volume extending between the side walls (20, 20′, 21, 21′) of the housing (14, 15).

9. A set as claimed in any claims 1 to 8, characterized in that the receptacle (18) is a part of a connector block.
